(19) United States
(12) Patent Application Publication
(10) Pub. No.: US 2007/0201085 A1
(43) Pub. Date: Aug. 30, 2007

(54) Image Processing Apparatus and Image Forming Apparatus

(75) Inventor: Atsushi YOKOCHI, Chiryu-shi (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya-shi (JP)

(21) Appl. No.: 11/679,500

(22) Filed: Feb. 27, 2007

(30) Foreign Application Priority Data
Feb. 28, 2006 (JP) 2006-052651

(51) Int. Cl. G06F 3/12

(52) U.S. Cl. 358/1.15

(57) ABSTRACT

An image processing apparatus can include an acquiring portion that acquires image data, a judging portion that determines if specified image data is included in image data, a history storage portion that stores history information relating to a number of times the judging portion judges that specified image data is included, wherein the number of times is X, an outputting portion that capable of outputting the image data, a prohibiting portion capable of at least one of stopping output of the image data and performing an invalidation output, a control portion that, when X is less than a predetermined number, causes the outputting portion to start output before a determination by the judging portion is completed, and when X is equal to or greater than the predetermined number, causes the outputting portion to start output after the judging portion determines that the image data does not include specified image data.

### CROSS REFERENCE TO RELATED APPLICATION

This application claims priority from Japanese Patent Application No. 2006-052651 filed Feb. 28, 2006 of this priority application is incorporated herein by reference.

### TECHNICAL FIELD

This disclosure relates to an image processing apparatus and an image forming apparatus.

### BACKGROUND

Various technology has been proposed for image processing apparatus (i.e. for use in color copiers and color printers) to prevent forgery of paper currency and marketable securities and the like. For example, a copier has been disclosed as configured to print image data (that is sent from an external information processing apparatus) onto a paper sheet and output the sheet, and concurrently therewith, to analyze the image data for certain image data for which output should be prohibited. If the prohibited data is present, the image forming apparatus blots out the image after feeding the paper sheet backward. Therefore, this apparatus may prevent malicious use of the specified image that was printed.

However, there is a concern that accompanying the incorporation of these kinds of anti-counterfeiting measures, ordinary users that are not attempting to printout a specified image would suffer disadvantages such as a drop in the processing speed.

In view of the above circumstances, there is a need for technology that, with respect to an image processing apparatus and image forming apparatus, prevents output of specified images for which output should be prohibited, and also realizes optimum processing for ordinary users that do not attempt to output a specified image.

### SUMMARY

An image processing apparatus, according to the present invention can include an acquiring portion that acquires image data, a judging portion that determines if specified image data is included in image data that is acquired by the acquiring portion, a history storage portion that stores history information relating to a number of times the judging portion judges that specified image data is included, wherein the number of times is X, an outputting portion that capable of outputting the image data, a prohibiting portion capable of at least one of stopping output of the image data and performing an invalidation output, a control portion that refers to the history information, and when X is less than a predetermined number, causes the outputting portion to start output the image data before a determination by the judging portion is completed, and when X is equal to or greater than the predetermined number, causes the outputting portion to start outputting the image data after the judging portion determines that the image data does not include specified image data.

### BRIEF DESCRIPTION OF THE DRAWINGS

Illustrative aspects in accordance with the invention will be described in detail with reference to the following figures wherein:

FIG. 1 is an oblique perspective view showing the outer appearance of a multifunction device according to one illustrative aspect of the present invention;

FIG. 2 is an oblique perspective view of the multifunction device that shows a state in which an original cover is raised;

FIG. 3 is a cross section showing a schematic configuration of a main body portion;

FIG. 4 is a block diagram that conceptually shows the electrical configuration of the multifunction device;

FIG. 5 is a flowchart that illustrates the flow of printing processing;

FIG. 6 is a flowchart that illustrates the flow of post-judgment output processing;

FIG. 7 is a flowchart that illustrates the flow of concurrent judgment and output processing;

FIG. 8 is a flowchart that illustrates the flow of print processing according to another illustrative aspect of the present invention;

FIG. 9 is a flowchart that illustrates the flow of print processing according to another illustrative aspect of the present invention;

FIG. 10 is a flowchart that illustrates the flow of print processing according to another illustrative aspect of the present invention;

FIG. 11 is a flowchart that illustrates the flow of print processing according to another illustrative aspect of the present invention;

FIG. 12 is a flowchart that illustrates the flow of print processing according to another illustrative aspect of the present invention;

FIG. 13 is a flowchart that illustrates the flow of print processing according to another illustrative aspect of the present invention; and

FIG. 14 is a flowchart that illustrates the flow of print processing according to another illustrative aspect of the present invention.

### DETAILED DESCRIPTION

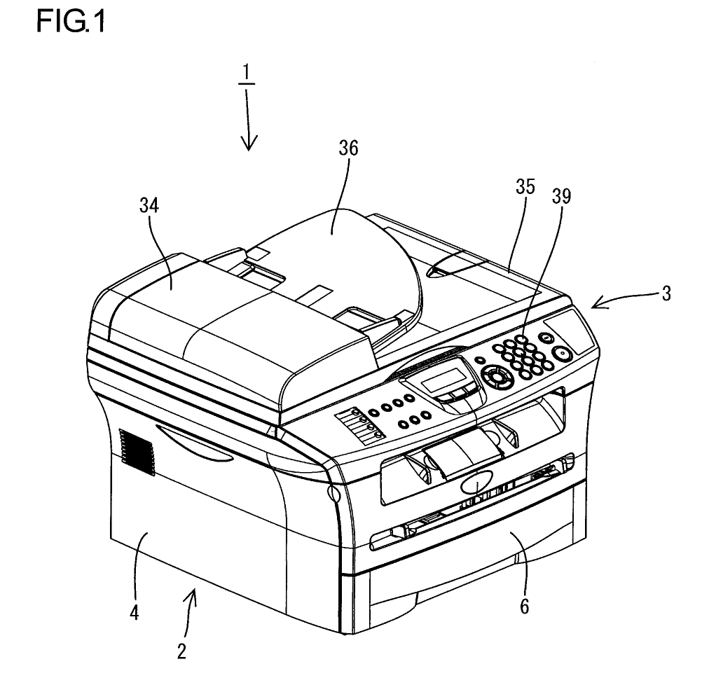

An illustrative aspect according to the present invention will be described with reference to FIG. 1 to FIG. 5.

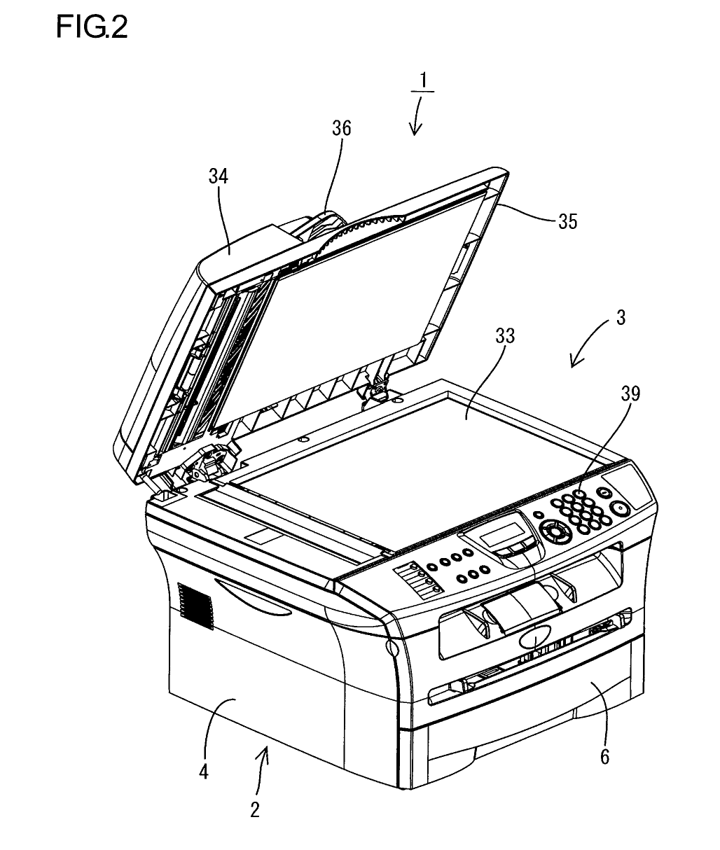

FIG. 1 is an oblique perspective view showing the outer appearance of a multifunction device 1 as one example of an image processing apparatus and image forming apparatus according to the present invention, and FIG. 2 is an oblique perspective view of the multifunction device 1 that shows a state in which an original cover 35 is raised. This multifunction device 1 is a multifunction peripheral apparatus that is equipped with various functions such as a printer function, a scanner function and a copy function. The multifunction device 1 comprises a main body portion 2 that houses an image forming portion 10 that forms an image on a recording medium 5 (such as a paper sheet, plastic sheet, or the like), and an original reading portion 3 that is provided on top of the main body portion 2 and reads an original image.

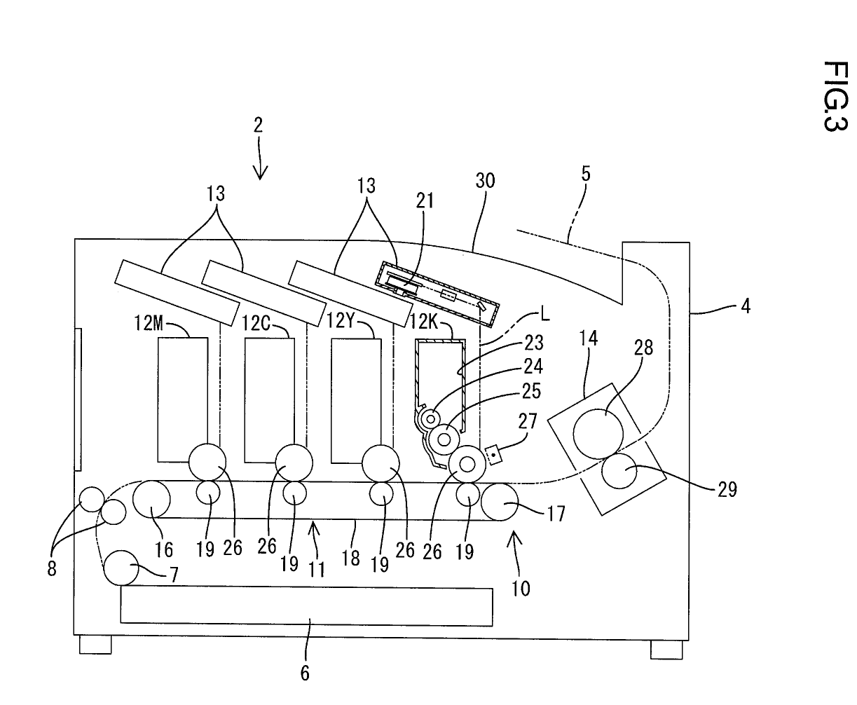

FIG. 3 is a cross section showing a schematic configuration of the main body portion 2. In the description below, the left side in this figure is taken to be the front.

The main body portion 2 comprises a substantially box-shaped main body casing 4, and a sheet feeding tray 6 in which a plurality of sheets of the recording medium 5 for forming an image are stacked is provided at the inside bottom of this main body casing 4 in a condition in which the sheet feeding tray 6 can be pulled out towards the front side. A supply roller 7 is provided at an upper region at the front end of the sheet feeding tray 6. By rotation of this supply roller 7, a recording medium 5 that is stacked at the uppermost position inside the sheet feeding tray 6 can be delivered to registration rollers 8 that are provided above the supply roller 7. At the registration rollers 8, the recording medium 5 is delivered onto the top of a backward belt unit 11.

The image forming portion 10 (one example of “outputting portion”) is provided above the sheet feeding tray 6 inside the main body casing 4. The image forming portion 10 comprises the belt unit 11, process units 12M, 12C, 12Y and 12K, exposing portions 13 and a fixing device 14.

In the belt unit 11, a conveying belt 18 is provided in a horizontally suspended condition between a pair of supporting rollers 16 and 17 at the front and rear thereof, and by rotational driving of the supporting roller 17 that is disposed at the rear side, the conveying belt 18 moves in a circulating manner such that the recording medium 5 that was placed on the top surface thereof is conveyed rearward. On the inner side of the conveying belt 18, transfer rollers 19 that are disposed facing respective photosensitive drums 26 of the process units 12, described later, are provided in a condition in which they are aligned in the front-to-rear direction.

Each of the exposing portions 13 emits a laser beam L that corresponds to one color of image data from a light source, and irradiates the laser beam L by high-speed scanning onto the surface of the respective photosensitive drums 26 via a mirror (i.e. of the polygon type or the like) that is rotationally driven by a motor 21.

The process units 12M, 12C, 12Y and 12K respectively comprise a toner containing chamber 23 that can contain toner of the colors magenta (M), cyan (C), yellow (Y), black (K) or the like, a supply roller 24, a developing roller 25, a photosensitive drum 26, a charging device 27 (for example, a scorotron charging device) and the like.

Toner that is discharged from the toner containing chamber 23 is supplied to the developing roller 25 by rotation of the supply roller 24, and at that time, the area between the supply roller 24 and the developing roller 25 is triboelectrically charged positively. Accompanying that rotation, the surface of the photosensitive drum 26 is uniformly charged to a positive charge by the charging device 27, and thereafter, the surface is exposed by the laser beam L from the exposing portion 13 to thereby form an electrostatic latent image thereon that corresponds to the image to be formed on the recording medium 5. Next, when the toner that is carried on the surface of the developing roller 25 is supplied to the surface of the photosensitive drum 26 by the rotation of the developing roller 25, the electrostatic latent image is visualized. Thereafter, the toner image that is carried on the surface of the photosensitive drum 26 is transferred to the recording medium 5 by a transfer bias voltage applied to a transfer roller 19 while the recording medium 5 passes between the photosensitive drum 26 and the transfer roller 19.

The fixing device 14 comprises a heat roller 28 that has a heat source, and a pressure roller 29 that presses the recording medium 5 to the heat roller 28 side. The fixing device 14 subjects the toner image that was transferred onto the recording medium 5 to heat fixing to the sheet surface. The recording medium 5 on which a toner image was heatedly fixed by the fixing device 14 is then conveyed upward to be discharged onto a discharge tray 30 that is provided on the top surface of the main body casing 4.

As shown in FIG. 1 and FIG. 2, the original reading portion 3 (one example of “acquiring portion”) is equipped with an original placement portion 33 comprising a transparent glass plate. An original is placed on this original placement portion 33 when reading an original by a so-called “flatbed” method. In this instance, an original can include, but is not limited to, a medium including an image. The top surface of the original placement portion 33 is covered by an original cover 35 provided with an ADF 34 (one example of “original feeding portion”) in a condition in the original cover 35 can open and close. The ADF 34 is equipped with an original tray 36 in which a plurality of originals can be stacked. The original tray 36 is provided with an original detection sensor (not shown) that utilizes a photosensor or the like for detecting if an original is stacked thereon. The ADF 34 conveys, one by one, originals that were stacked on the original tray 36, and discharges each original after the original in question was read by a CCD image sensor 37 that is described next.

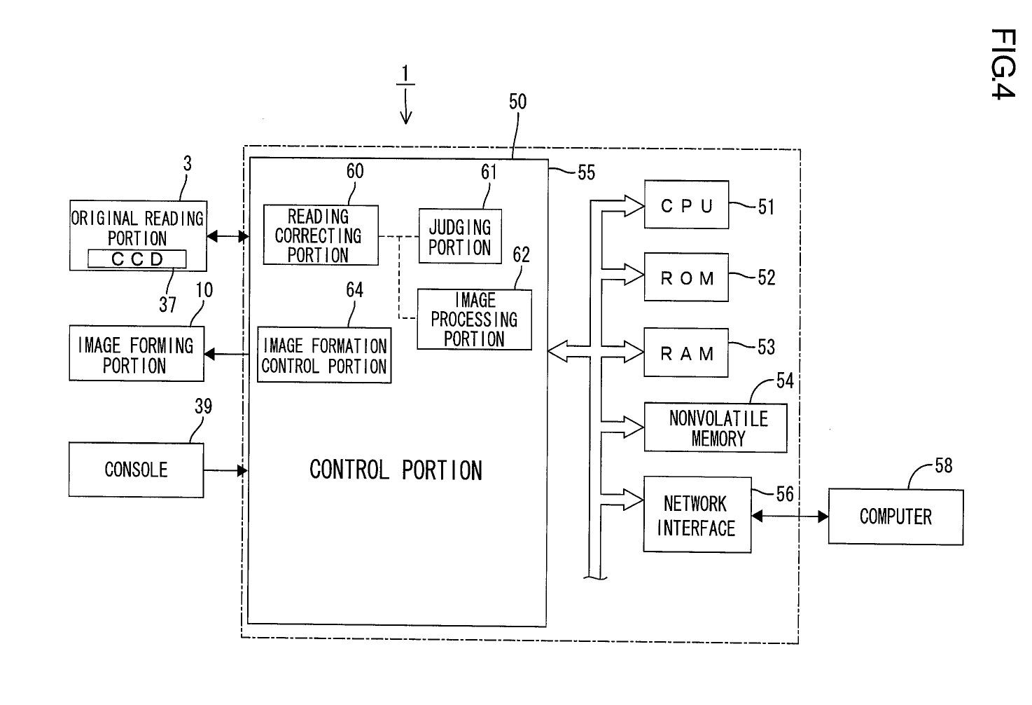

The CCD image sensor 37 (one example of “reading devise”, see FIG. 4) is provided below the original placement portion 33. The CCD image sensor 37 comprises photodiodes that are disposed in a row in the front to rear direction. When a strong light is shone on an original by a light source, the light is reflected and is received by the individual photodiodes. The photodiodes then convert the light intensity (brightness) of the reflected light for each pixel of the original into an electrical signal. At the original reading portion 3, these electrical signals are converted into digital data by an A/D converter (not shown), to thereby read the image on the original as image data.

Reading of an original may be performed by placing the original on the original placement portion 33 or by utilizing the ADF 34. In the former case, the CCD image sensor 37 moves in a left to right direction along the plate surface of the original placement portion 33, and at that time reading of the original on the original placement portion 33 is performed one line at a time. In the latter case, the CCD image sensor 37 is fixed at a position at the left end of the original placement portion 33, and reading of the original is performed one line at a time by conveying the original (via the ADF 34) to a position at which the original can be read by the CCD image sensor 37.

A console 39 includes various buttons and the like is provided on the top surface of a front end part of the original reading portion 3. Using this console 39, a user can input various commands for operating the multifunction device 1, such as a print command for executing print processing for an original.

Next, the electrical configuration of the multifunction device 1 will be described. FIG. 4 is a block diagram that conceptually shows the electrical configuration of the multifunction device 1. The multifunction device 1 comprises a control apparatus 50 that consists of a CPU 51, a ROM 52, a RAM 53, a nonvolatile memory 54, a control portion 55, a network interface 56 and the like.

Various control programs for controlling the multifunction device 1, various settings and initial values and the like can be stored in the ROM 52. The RAM 53 (one example of “data storage portion”) is used as a work area to which various control programs are read out, or as a storage area that temporarily stores image data. History information, to be described later, and the like are stored in the nonvolatile memory 54 (one example of “history storage portion”). By connecting an information processing apparatus such as an external personal computer 58 to the network interface 56, mutual data communication is enabled between the external personal computer 58 and the network interface 56. In accordance with control programs that were read out from the ROM 52, the CPU 51 (one example of “prohibiting portion” and “control portion”) controls each component of the multifunction device 1 through the control portion 55 while storing the processing results in the RAM 53 or the nonvolatile memory 54.

The control portion 55 can include an ASIC (Application Specific Integrated Circuit) and be electrically connected to each portion such as the original reading portion 3, the image forming portion 10 and the console 39 described above. The control portion 55 includes a reading correcting portion 60 that is connected to the original reading portion 3, and a judging portion 61 and an image processing portion 62 that are connected to the reading correcting portion 60. Concurrent with a reading operation by the original reading portion 3, the reading correcting portion 60 receives the image data that was acquired by the original reading portion 3 and performs correction processing such as gamma correction, shading compensation and the like on the selected image data.

The judging portion 61 receives image data that was corrected by the reading correcting portion 60 in parallel with a reading operation by the original reading portion 3, and judges if specified images (such as paper currency or marketable securities) are included in the image contents of that image data based on predetermined judging conditions. A judging condition, for example, can include the concordance rate between the image data and previously stored reference data is used. More specifically, in this case the judging portion 61 determines the concordance rate between the image data and the previously stored reference data, and when that concordance rate is equal to or greater than a predetermined threshold value, the judging portion 61 determines that the image data includes the specified image data. Further, when the concordance rate is less than the threshold value the judging portion 61 determines that the image data does not include the specified image data. Also, the number of times that the judging portion 61 determines that specified image data is included in image data is stored as history information in the nonvolatile memory 54.

The image processing portion 62 receives image data that was corrected by the reading correcting portion 60 in parallel with a reading operation by the original reading portion 3, and performs processing to convert that image data (RGB image data) into image data corresponding to the respective colors magenta, cyan, yellow and black (MCYK image data) and the like, and stores the image data after that conversion processing in the RAM 53.

The control portion 55 can also include an image formation control portion 64 that is connected to the image forming portion 10. Under the control of the CPU 51, the image formation control portion 64 reads out image data that has undergone conversion by the image processing portion 62 and which is stored in the RAM 53, and prints out an image based on that image data on the recording medium 5 by controlling the image forming portion 10.

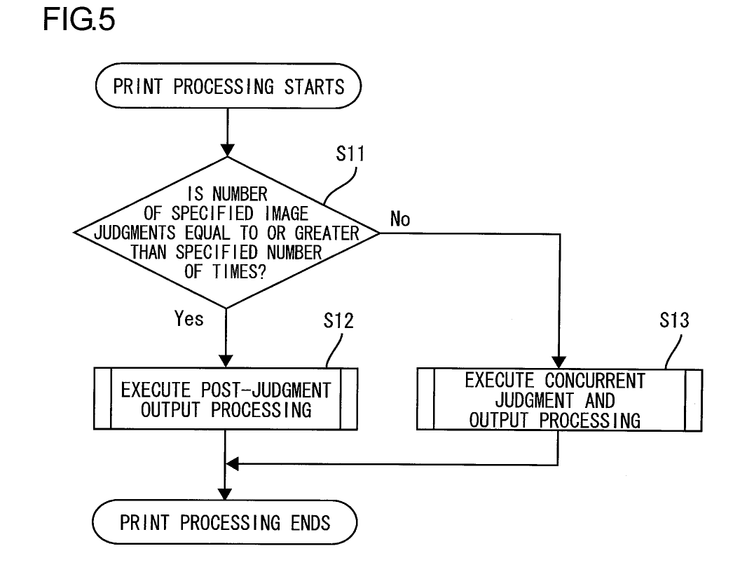

FIGS. 5 to 7 are flowcharts that illustrate the flow of control processing executed by the CPU 51.

According to this illustrative aspect, a case is described in which an original image that was read by the original reading portion 3 is printed out on the recording medium 5.

When a user places an original on the original placement portion 33 or the original tray 36 and inputs a print command instructing printing (copying) from the console 39, the CPU 51 receives that print command and starts the print processing shown in FIG. 5. The CPU 51 first refers to history information that is stored in the nonvolatile memory 54 and determines if the number of times that the judging portion 61 determines that specified image data (included in image data) is equal to or greater than a predetermined number (S11). Although one time is preferable as this predetermined number, the predetermined number may be two or more.

When it is determined that specified image data is equal to or greater than the predetermined number (S11: Yes), post-judgment output processing is executed that starts printout after completion of judgment processing by the judging portion 61 (S12).

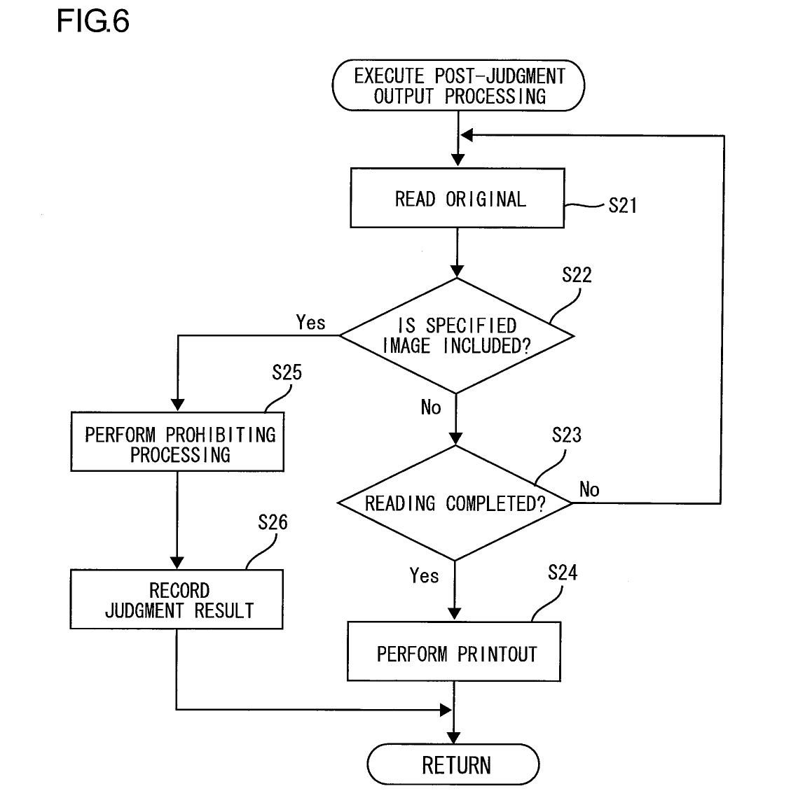

In this post-judgment output processing, as shown in FIG. 6, the CPU 51 first causes the original reading portion 3 to execute an operation to read the original image (S21). As described previously, in parallel with this reading operation, the judging portion 61 makes a judgment regarding if image data that was acquired by the original reading portion 3 (image data that underwent correction processing at the reading correcting portion 60) includes specified image data. Further, in parallel therewith, conversion processing of image data (image data that underwent correction processing) is performed at the image processing portion 62, and the image data after completion of the conversion processing is stored in sequence, for example, in the RAM 53.

Next, the CPU 51 determines if the judging portion 61 determines that the image data includes specified image data (S22) When the judging portion 61 determines that no specified image data is included (S22: No), the CPU 51 determines if reading operations were completed for all of the original images (S23), and when the reading operations have not been completed (S23: No), the processing returns to S21 to repeat the processing from S21 to S23.

When the reading operations have been completed (S23: Yes), meaning that the judging portion 61 determines that specified image data is not included in all of the image data, and therefore the image data that underwent conversion processing that is stored in the RAM 53 is read by the image formation control portion 64, a copy of the image is printed out on a recording medium 5 by the image forming portion 10 (S24). When printout has been completed for all of the image data in this manner, the CPU 51 concludes the post-judgment output processing and ends this print processing.

Further, when the judging portion 61 determines that the image data includes specified image data (S22: Yes), the CPU 51 executes prohibiting processing for preventing the execution of printout based on that image data (S25). According to this prohibiting processing, for example, the mechanical operations of the image forming portion 10 are placed in a stopped state to stop printout of the image data. Alternatively, according to this prohibiting processing, invalidation processing is performed that alters the image data that was stored in the RAM 53, and printout of an image based on image data that underwent that invalidation processing is executed by the image forming portion 10. This can also be referred to a an invalidation image. An invalidation image may refer to, for example, an image in which a pattern or characters are superimposed on the original image or to an image that is completely different to the original image (including blotting out and the like).

After executing the above described prohibiting processing, the CPU 51 records the result of the determination by the judging portion 61 on the nonvolatile memory 54 (S26). More specifically, the CPU 51 processes this information and the number of times specified image data is determined to be included is stored as history information on the nonvolatile memory 54 (hereunder, referred to as “number of specified image judgment(s)”). The CPU 51 then concludes the post-judgment output processing and ends this print processing.

In contrast, at S11 in FIG. 5, when the CPU 51 determines that the number of specified image judgment(s) is less than the predetermined number (S11: No), the CPU 51 executes concurrent judgment and output processing in which a judgment by the judging portion 61 and printout by the image forming portion 10 are performed concurrently (S13).

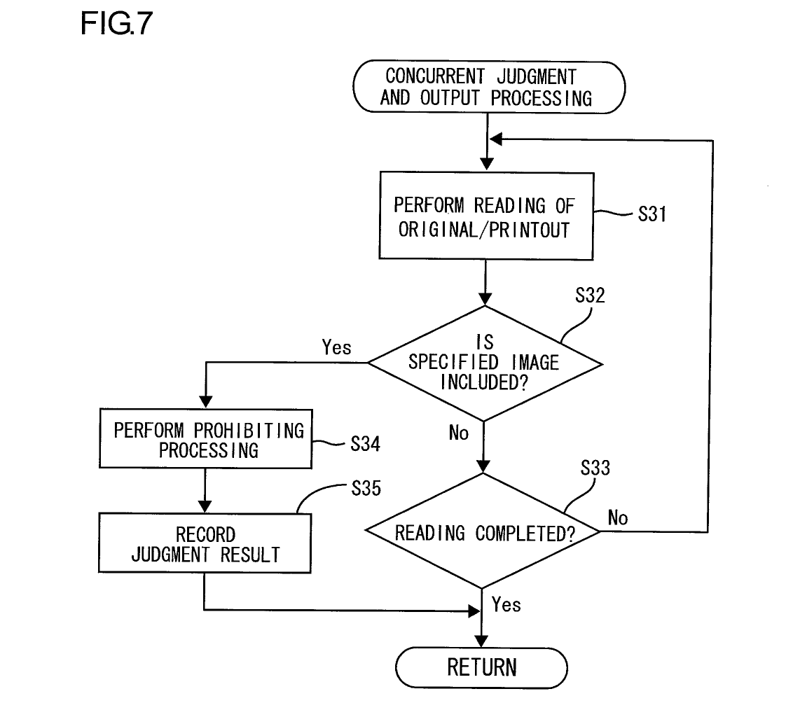

In this concurrent judgment and output processing, as shown in FIG. 7, the CPU 51 first causes the original reading portion 3 to execute an operation to read the original image, and concurrent therewith places the image formation control portion 64 in a state in which printout is enabled (S31). As described previously, in parallel with the reading operation by the original reading portion 3, judgment processing with respect to the acquired image data (image data that underwent correction processing) is performed at the judging portion 61. Further, in parallel therewith, after undergoing conversion processing at the image processing portion 62, the image data that was acquired by the original reading portion 3 (image data that underwent correction processing) is stored in sequence in the RAM 53.

In this case, reading by the image formation control portion 64 of image data that underwent conversion processing and was stored in the RAM 53 and printout onto the recording medium 5 by the image forming portion 10 starts when the amount of image data accumulated in the RAM 53 reaches a predetermined output commencement threshold value. Therefore, the time at which the image forming portion 10 starts printing onto the recording medium 5 is later than the time the acquisition of image data by the original reading portion 3 starts until the time the image data accumulated in the RAM 53 reaches a predetermined data amount.

Next, the CPU 51 determines if the judging portion 61 determines that the image data includes specified image data (S32) When it is determined that the image data does not include specified image data (S32: No), the CPU 51 determines if an operation by the original reading portion 3 to read all of the original images is completed (S33). If the reading operation is not completed (S33: No), the operation returns to S31 to repeat the processing from S31 to S33. When the reading operation is completed (S33: Yes), the CPU 51 quits this concurrent judgment and output processing and ends the print processing.

Further, when the judging portion 61 determines that the image data includes specified image data (S32: Yes), the CPU 51 executes prohibiting processing to prevent execution of printout based on that image data (S34). According to this prohibiting processing, for example, the mechanical operations of the original reading portion 3 that is in the process of performing a reading operation (or the image forming portion 10 that is in the process of performing a printout operation) are placed in a stopped state to stop printout of the image data. Alternatively, according to this prohibiting processing, the image forming portion 10 executes printout of an image that is based on image data that underwent that invalidation processing. Methods of performing invalidation processing can include, for example, a method which makes the image data acquired by the original reading portion 3 abnormal by stopping the movement of the CCD image sensor 37 (when reading an original that was placed on the original placement portion 33) or turning off the light source of the CCD image sensor 37 or the like. Invalidation processing can also include, for example, a method that adds some form of alteration to the image data when performing conversion processing at the image processing portion 62, or a method that adds some form of alteration to the image data when reading out the image data from the RAM 53 using the image formation control portion 64.

After executing the above described prohibiting processing, the CPU 51 increments (by one) the specified image judgment(s) that is stored as history information on the nonvolatile memory 54 (S35) to conclude the post-judgment output processing and then ends this print processing.

According to the present illustrative aspect as described above, since printout is started prior to completion of a judgment regarding the image data when the number of times it is judged that specified image data is included in image data is less than a predetermined number (for example, when it is 0 times), it is possible to reduce cases in which an ordinary user (who is not attempting to printout a specified image) is compelled to wait for an unnecessary waiting time. Further, when the number of times it is judged that specified image data is (included in image data) is equal to or greater than a predetermined number, the output will not start until after it is judged that the relevant image data does not include specified image data. Thus, it is possible to prevent output of even one portion of a specified image.

Further, when the number of specified image judgment (s) is equal to or greater than a predetermined number, while performing a judgment regarding image data acquired by the original reading portion 3, that image data is accumulated on the RAM 53 and output of the image data is performed after the determination is completed. It is thereby possible to omit processing in which image data for judgment is acquired by the original reading portion 3 at a stage prior to acquiring image data for output, as occurs in the illustrative aspect to be described next.

Furthermore, since original reading device (that is used when scanning or copying an original image) has the highest possibility of being utilized as a means for attempting to output a specified image, a counterfeiting act can be effectively prevented by applying the present invention to the multifunction device 1 that comprises the original reading portion 3 as this kind of original reading device.

Further, where one portion of a specified image is output a plurality of times (when the predetermined number of a specified image judgment that is the reference for starting output prior to completion of a judgment was set as two or more times), there is a risk that those portions may be synthesized for malicious use. This type of situation can be prevented by setting the predetermined number at one.

Furthermore, since history information regarding judgment results is stored in a nonvolatile memory, that history information is not erased even when the power of the multifunction device 1 is turned off.

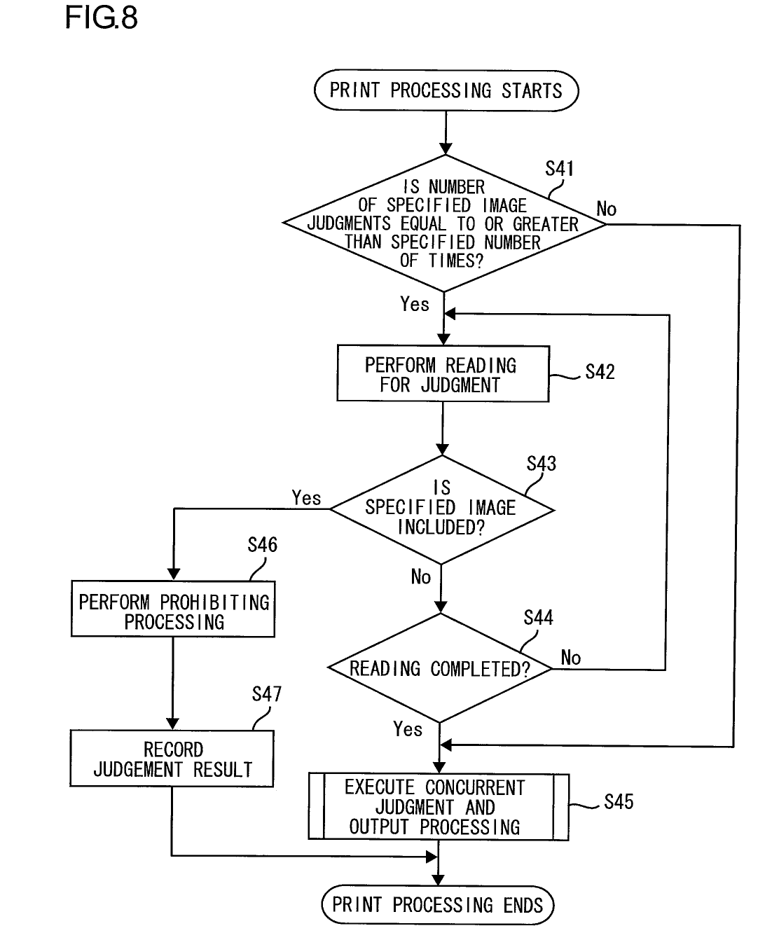

Next, another illustrative aspect of this invention will be described with reference to the flowchart of FIG. 8.

According to this illustrative aspect, processing in a case where an image that was read from an original placed on the original placement portion 33 is printed out onto a recording medium 5 is described. The configuration of the multifunction device 1 is the same as in the above described illustrative aspect.

When the CPU 51 starts print processing, it first refers to history information stored in the nonvolatile memory 54 to determine if the number of specified image judgment (s) is equal to or greater than the predetermined number (S41).

When the number of specified image judgment (s) is equal to or greater than the predetermined number (S41: Yes), the CPU 51 causes the original reading portion 3 to execute a reading operation for judgment in order to acquire image data for determination (S42). This reading operation for judgment is performed at a lower resolution than a reading operation for acquiring the normal image data for output, and the operation is thus performed faster than normal. The data amount of the image data for judgment that is acquired in this manner is smaller than that of image data for output that is used for printout. Further, conncurrent with this reading operation for judgment, the judging portion 61 determines if the acquired image data for judgment (image data that underwent correction processing by the reading correcting portion 60) includes specified image data. In this connection, this image data for judgment is not subjected to conversion processing by the image processing portion 62.

The CPU 51 then determines if the judging portion 61 determined that the image data for judgment includes specified image data (S43). When it is judged that specified image data is not included (S43: No), the CPU 51 determines if a reading operation was completed for all of the original images (S44), and if the reading operation has not completed (S44: No) the operation returns to S42 to repeat the processing from S42 to S44.

When the reading operation was completed (S44: Yes) it means that the judging portion 61 determines that specified image data is not included in all of the image data for judgment, and therefore the CPU 51 executes concurrent judgment and output processing (see FIG. 7) (S45).

When the judging portion 61 determines that the image data includes specified image data (S43: Yes), the CPU 51 executes prohibiting processing for preventing printout based on that image data (S46), and subsequently increments (by one) the specified image judgment (s) that is stored as history information on the nonvolatile memory 54 (S47).

In contrast, in S41, when the CPU 51 determines that the number of specified image judgment (s) is less than the predetermined number (S41: No), it immediately executes concurrent judgment and output processing (see FIG. 7) without performing a reading operation for judgment (S45).

In a case where, as in the aforementioned illustrative aspect, acquired image data is used for both a determination by the judging portion 61 and output by the image forming portion 10, in order to start output of the image data after completion of the judgment, image data should be stored on a storage means (such as the RAM 53) until completion of the judgment. Thus, a large capacity is may be preferred for the storage means. But, according to this illustrative aspect, image data for judgment is acquired first, and after that judgment is completed, output is performed concurrently with acquisition of image data for output, and it is therefore possible to reduce the capacity of the storage means used.

Further, since a reading operation for acquiring image data for judgment is performed at a lower resolution than a reading operation for acquiring image data for output, the time required for a reading operation to acquire image data for judgment can be decreased.

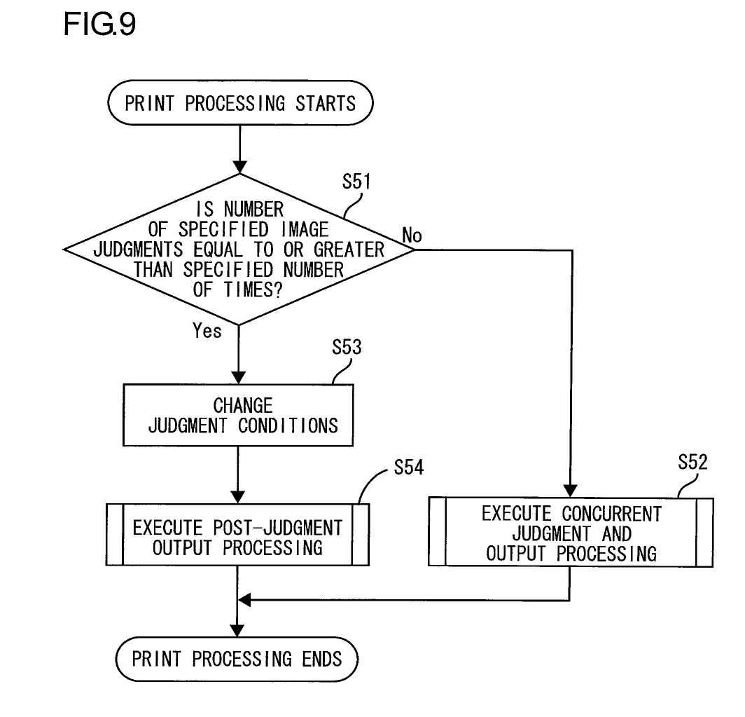

Next, another illustrative aspect of this invention will be described with reference to the flowchart shown in FIG. 9.

According to this illustrative aspect, processing in a case where an original image that was read by the original reading portion 3 is printed out onto a recording medium 5 is described.

When the CPU 51 starts print processing, it first refers to history information stored in the nonvolatile memory 54 to determine if the number of specified image judgment (s) is equal to or greater than the predetermined number (S51). When the number of specified image judgment(s) is less than the predetermined number (S51: No), the CPU 51 executes concurrent judgment and output processing (see FIG. 7) (S52). In this connection, in this concurrent judgment and output processing, the judging portion 61 makes a determination based on a first judgment condition provided as the intial settings.

When the number of specified image judgment (s) is equal to or greater than the predetermined number (S51: Yes), the CPU 51 changes the judgment condition during operation of the judging portion 61 from the first judgment condition to second judgment condition (S53), and subsequently executes post-judgment output processing (see FIG. 6) (S54).

In the second judgment conditions, for example, the conditions for determining that specified image data is not included in image data are made stricter than the first judgment condition. More specifically, for example, when making a judgment using the aforementioned concordance rate, the threshold value of a concordance rate for judging if specified image data is included is set lower in the second judgment condition than in the first judgment condition.

Alternatively, the number of judgment items in the second judgment condition is made greater than those of the first judgment condition. More specifically, for example, the second judgment condition may include a judgment item relating to the color or size of an image that is the origin of the image data (i.e. an item for judging if an image based on the image data is the color or size of an image that is assumed to be a specified image), while the first judgment condition do not include that judgment item.

According to this illustrative aspect, when the number of specified image judgment (s) is less than the predetermined number, a judgment is performed on the basis of judgment conditions that are not strict in a relative sense. Therefore, when an ordinary user who does not attempt to output a specified image, for example, attempted to output an image that is not a specified image, it is possible to prevent the inconvenience of an image in question being stopped from output due to an erroneous judgment. Further, since judgment is performed based on stricter judgment conditions when the number of specified image judgment(s) is equal to or greater than the predetermined number, output of a specified image can be prevented more surely.

Furthermore, when the specified image judgment (s) is less than the predetermined number, that is, with respect to a user that is recognized as not attempting to output a specified image, speedy output processing can be performed by reducing the judgment items.

Further, when the specified image judgment(s)judgment is equal to or greater than the predetermined number, by lowering the threshold value of the concordance rate for judging image data to be specified image data, it becomes easier to make a judgment that an image includes a specified image, and output of a specified image can thus be more easily suppressed.

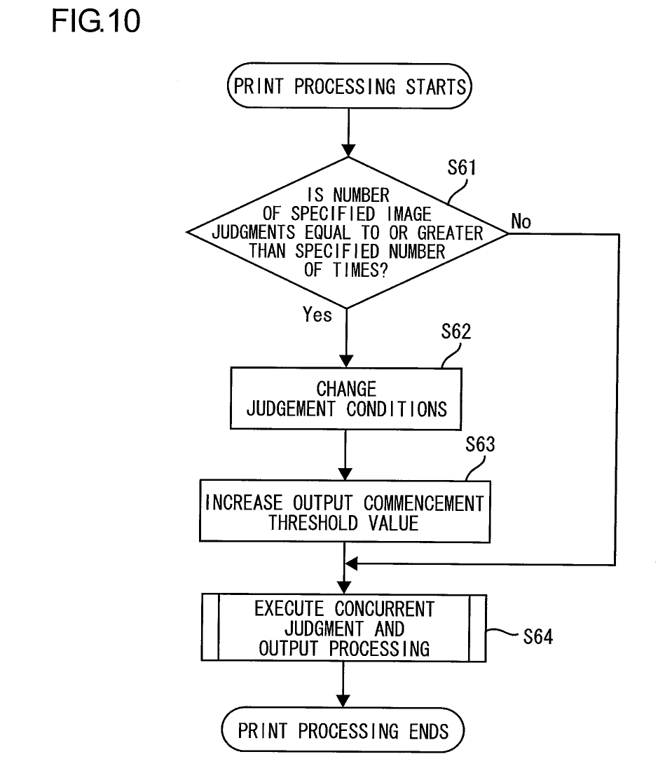

Next, another illustrative aspect of this invention will be described with reference to the flowchart shown in FIG. 10.

According to this illustrative aspect, processing in a case where an original image that was read by the original reading portion 3 is printed out onto a recording medium 5 is described.

When the CPU 51 starts print processing, it first refers to history information stored in the nonvolatile memory 54 to determine if the number of specified image judgment (s) by the judging portion 61 is equal to or greater than a predetermined number (S61). When the number of specified image judgment(s)judgment is equal to or greater than the predetermined number (S61: Yes), the CPU 51 changes the judgment conditions of the judging portion 61 from first judgment condition (as the initial setting) to the second judgment condition (S62). Similarly to the aforementioned illustrative aspect, in the second judgment condition a condition for judging that specified image data is not included is made stricter that in the first judgment condition, or there are more judgment items than in the first judgment condition.

Subsequently, the CPU 51 increases the aforementioned output commencement threshold value that is a condition for starting printout by the image forming portion 10 from a first threshold value that is the initial value to a second threshold value that is greater than the first threshold value (S63), and thereafter executes concurrent judgment and output processing (see FIG. 7) (S64). In contrast, in S61, when the CPU 51 determines that the number of times it is judged that specified image data is included is less than the predetermined number (S61: No), the CPU 51 executes concurrent judgment and output processing without passing through the steps S62 and S63 (S64).

Thus, when the number of specified image judgment(s) is less than the predetermined number (S61: No), printout is started when the amount of image data stored in the RAM 53 reaches a first threshold value, and when number of specified image judgment(s) is equal to or greater than the predetermined number (S61: Yes), printout is started when the amount of image data stored in the RAM 53 reaches a second threshold value that is larger than the first threshold value. Thus, when there is an increase in the number of specified image judgment(s), the time until output accordingly increases.

According to this illustrative aspect, when the number of specified image judgment(s) is equal to or greater than a predetermined number, the amount of image data that is accumulated on the RAM 53 (until the start of output) is larger than in a case in which the number of specified image judgment (s) is less than the predetermined number. Thus, since output is started at an early stage when the number of specified image judgment(s)judgment is less than the predetermined number, it is possible to avoid a situation in which an ordinary user (that does not attempt to output a specified image) is compelled to wait a long waiting time. Further, since the time for starting output is later when the number of specified image judgment(s) is equal to or greater than the predetermined number, it is possible to inhibit output of that image data in a case where image data includes specified image data.

Thus, as the time until output starts to increase, the number of specified image judgment (s) increases. Therefore, since output is started at an early stage when the number of specified image judgment(s) is small, it is possible to avoid a situation in which an ordinary user (that does not attempt to output a specified image) is compelled to wait a long waiting time. Further, since output is started at a later time when the number of specified image judgment (s) is large, it is possible to take that amount of time to perform highly precise judgment processing and thereby effectively inhibit output of a specified image. In addition, since the time at which output starts is delayed, it is possible to reduce the output amount at the point in time when prohibiting processing is performed in a case where image data includes specified image data.

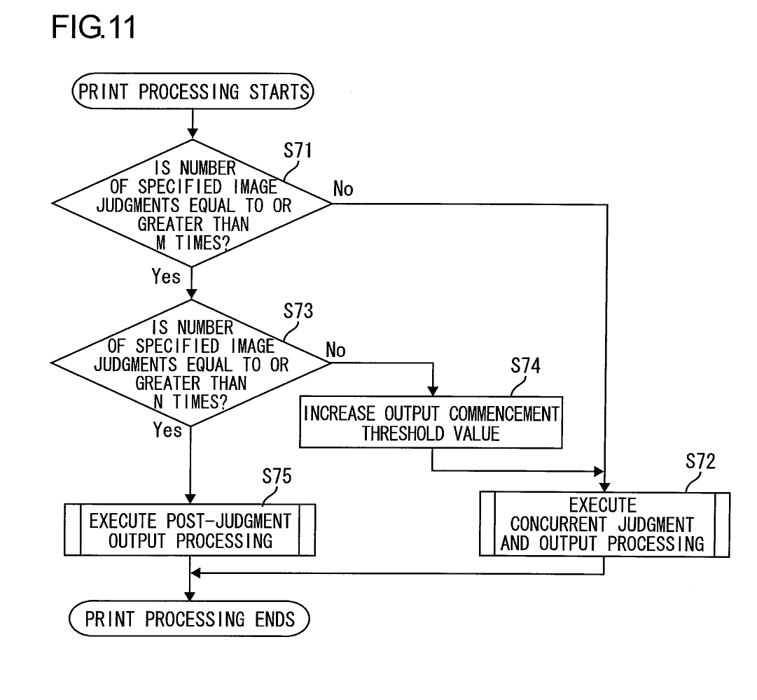

Next, another illustrative aspect of this invention will be described with reference to the flowchart shown in FIG. 11.

According to this illustrative aspect, processing in a case where an original image that was read by the original reading portion 3 is printed out onto a recording medium 5 is described.

When the CPU 51 starts print processing, it first refers to history information stored in the nonvolatile memory 54 to determine if the number of specified image judgment (s) by the judging portion 61 is equal to or greater than M times (S71). In this case, although the value of M is preferably 1, it may also be 2 or more. When the number of times it is judged that specified image data is included is less than M times (S71: No), the CPU 51 starts concurrent judgment and output processing (see FIG. 7) (S72).

When the number of specified image judgment (s) is equal to or greater than M times (S71: Yes), the CPU 51 next determines if the number of specified image judgment (s) is equal to or greater than N times (S73). In this case N>M.

When the number of times it is judged that specified image data is included is less than N times (S73: No), the CPU 51 increases the output commencement threshold value for starting printout (by the image forming portion 10) to a value greater than the initial value (S74). The amount of increase in the output commencement threshold value is changed in a multistep manner in accordance with the number of specified image judgment (s). More specifically, when the number of specified image judgment (s) is equal to or greater than M times and less than N times, as the number of times of the said judgment increases, the amount of the output commencement threshold value from the initial value increases.

Next, the CPU 51 executes concurrent judgment and output processing (see FIG. 7) (S72). At this time, the time from the start of reading of an original by the original reading portion 3 until printout by the image forming portion 10 starts, this time increases from the normal time (when the number of specified image judgment (s) is less than M times) in accordance with the amount of increase in the output commencement threshold value at S74.

In contrast, at S73, when the number of specified image judgment(s) is equal to or greater than N times (S73: Yes), the CPU 51 executes post-judgment output processing (see FIG. 6) (S75).

According to this illustrative aspect, the time until the start of output increases in a multistep manner in accordance with the increase in the number of specified image judgment (s). Therefore, since output starts at an early stage when the number of specified image judgment (s) is small, it is possible to avoid a situation in which an ordinary user (that does not attempt to output a specified image) is compelled to wait a long waiting time. Further, since output is started at a later time when the number of specified image judgment (s) is large, it is possible to take that amount of time to perform highly precise judgment processing and thereby effectively inhibit output of a specified image.

In this connection, according to the present illustrative aspect, when the capacity of the RAM 53 for storing image data is insufficient, instead of the post-judgment output processing at S75, the capacity of the RAM 53 that is used can be decreased by executing concurrent judgment and output processing after performing a reading operation for judgment as in S42 to S47 of FIG. 8.

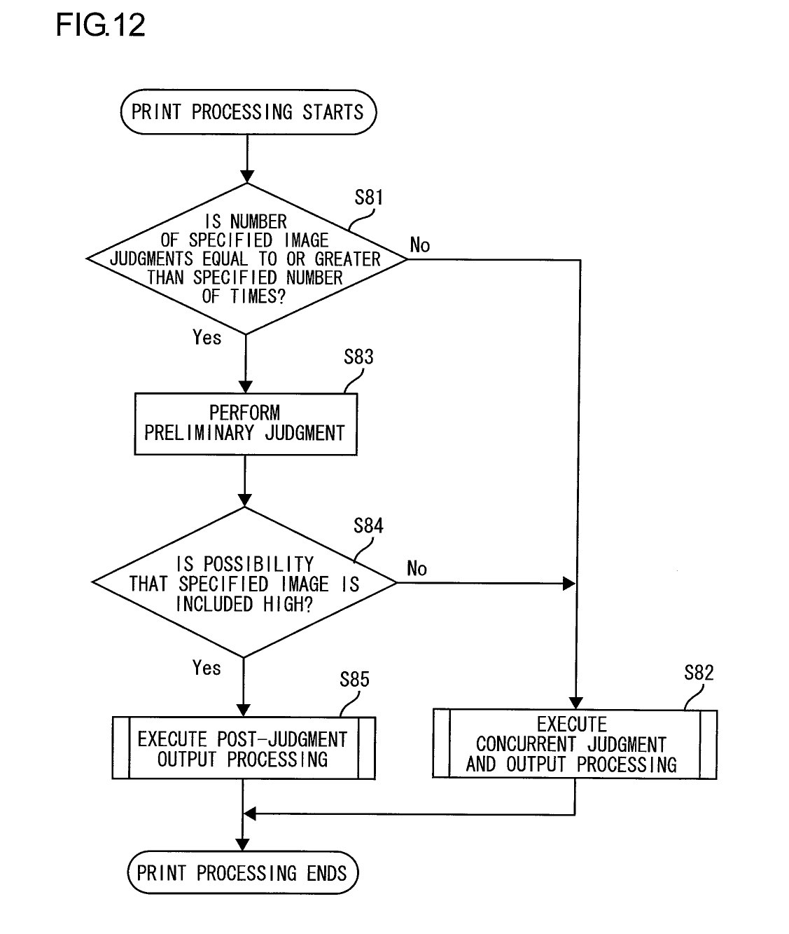

Next, a further illustrative aspect of this invention will be described with reference to the flowchart shown in FIG. 12.

According to this illustrative aspect, processing in a case where an image that was read from an original that was placed on the original placement portion 33 is printed out onto a recording medium 5 is described.

When the CPU 51 starts print processing, it first refers to history information stored in the nonvolatile memory 54 to determine if the number of specified image judgment (s) (by the judging portion 61) is equal to or greater than a predetermined number (S81). When the number of specified image judgment(s) is less than the predetermined number (S81: No), the CPU 51 executes concurrent judgment and output processing (see FIG. 7) (S82).

Further, when the number of specified image judgment (s) is equal to or greater than the predetermined number (S81: Yes), the CPU 51 executes preliminary judgment processing (S83). This preliminary judgment processing is processing in which the judging portion 61 determines if there is a high possibility that specified image data is included in the image data, and it is performed in a shorter time that the normal judgment processing (main judgment processing) that determines if specified image data is included in the image data.

More specifically, in this preliminary judgment processing, for example, reading of one part of an original is performed at the original reading portion 3, the size of that original (main scanning direction only) is determined by the judging portion 61 based on the acquired image data, and judgment is made by examining if that original size matches the size of specified image data that was previously registered. Alternatively, reading of one part of an original is performed at the original reading portion 3, and the judging portion 61 then makes a judgment based on the acquired image data by examining if the color of that original image matches the color of a specified image that was previously registered.

Next, the CPU 51 determines if it is judged by the preliminary judgment processing that there is a high possibility that specified image data is included in the image data (S84), and when the CPU 51 determines that the possibility that specified image data is included is not high (S84: No), it executes concurrent judgment and output processing (S82). When the CPU 51 determines that the possibility that specified image data is included is high (S84: Yes), it executes post-judgment output processing (see FIG. 6) (S85).

According to the present illustrative aspect, when it is judged by high-speed preliminary judgment processing that there is a low possibility that specified image data is included, output is started before completion of a judgment by the normal judgment processing (main judgment processing) and therefore a delay in the output processing can be prevented. In particular, when a plurality of users use the multifunction device 1, it is possible to suppress the occurrence of a situation in which other users suffer the disadvantage of a decrease in processing speed when one user attempts to output a specified image.

Further, since the color or size of an original image can be used as a judgment item in the preliminary judgment processing, it is possible to complete the judgment at an early stage.

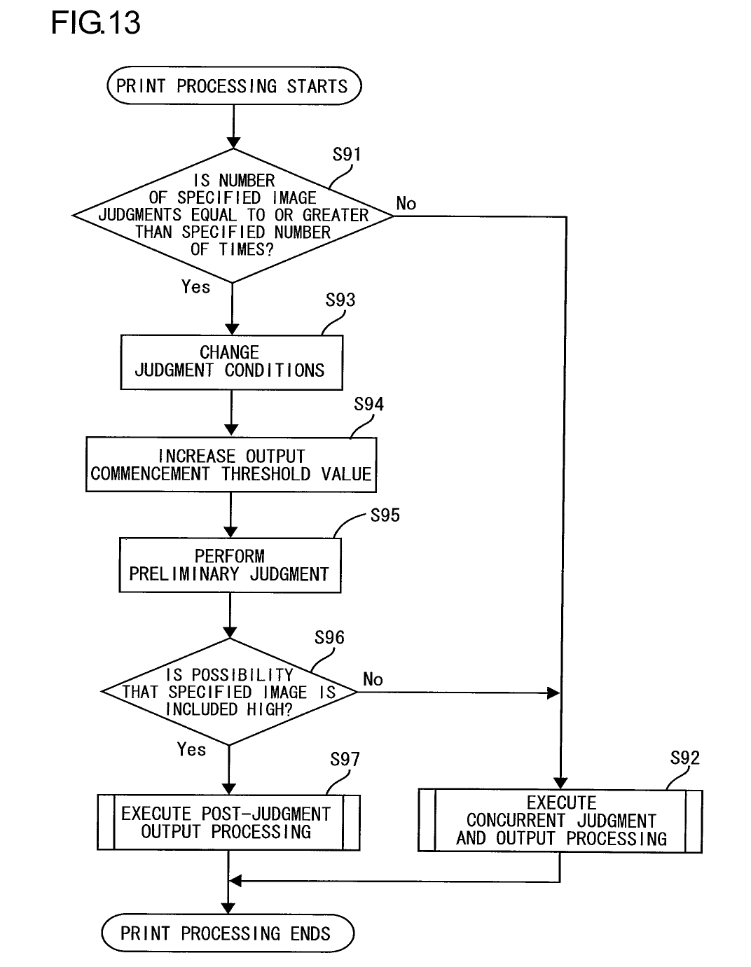

Next, a further illustrative aspect of this invention will be described with reference to the flowchart shown in FIG. 13.

According to this illustrative aspect, processing in a case where an image that was read from an original that was placed on the original placement portion 33 is printed out onto a recording medium 5 is described.

When the CPU 51 starts print processing, it first refers to history information stored in the nonvolatile memory 54 to determine if the number of specified image judgment (s) which is performed by the judging portion 61 is equal to or greater than the predetermined number (S91). When the number of specified image judgment (s) is less than the predetermined number (S91: No), the CPU 51 executes concurrent judgment and output processing (see FIG. 7) (S92).

When the number of times it is judged that specified image data is included is equal to or greater than the predetermined number (S91: Yes), the CPU 51 changes the judgment conditions of the judging portion 61 from the first judgment condition (being the initial value) to the second judgment condition (S93). Similar to the aforementioned illustrative aspect, in the second judgment condition, a condition for judging that specified image data is not included is made stricter than in the first judgment condition, or there are more judgment items than in the first judgment condition. Next, the CPU 51 increases the output commencement threshold value for commencing printout by the image forming portion 10 from the first threshold value (being the initial value) to a second threshold value that is greater than the first threshold value (S94).

Subsequently, the CPU 51 executes preliminary judgment processing (S95) to determine if there is a high possibility that specified image data is included in the image data (S96), and when the possibility that specified image data is included is not high (S96: No) the CPU 51 executes concurrent judgment and output processing (S92). When the CPU 51 determines that the possibility that specified image data is included is high (S96: Yes), it executes post-judgment output processing (see FIG. 6) (S97).

According to the present illustrative aspect, similarly to the illustrative aspect shown in FIG. 9, when the number of specified image judgment (s) is less than the predetermined number, a judgment is performed on the basis of judgment conditions that are not strict in a relative sense. Therefore, when an ordinary user attempts to output an image that is not a specified image, it is possible to prevent the user suffering the disadvantage that the image in question cannot be output due to an erroneous judgment. Further, since judgment is performed based on stricter judgment conditions when the number of specified image judgment(s) is equal to or greater than the predetermined number, output of a specified image can be prevented more surely.

Further, similarly to the illustrative aspect shown in FIG. 10, since output is started at a nearly stage when the number of specified image judgment(s) is less than the predetermined number, it is possible to avoid a situation in which an ordinary user (who does not attempt to output a specified image) is compelled to wait a long waiting time. Further, since the time of starting output is later when the number of specified image judgment(s)is equal to or greater than the predetermined number, it is possible to inhibit output of image data in a case where the image data includes specified image data.

Furthermore, similar to the illustrative aspect shown in FIG. 12, when it is judged by high-speed preliminary judgment processing that there is a low possibility that specified image data is included, output is started before completion of a judgment by the normal judgment processing (main judgment processing) and therefore a delay in the output processing can be prevented. In particular, when a plurality of users use the multifunction device 1, it is possible to suppress the occurrence of a situation in which other users suffer the disadvantage of a decrease in processing speed when one user attempts to output a specified image.

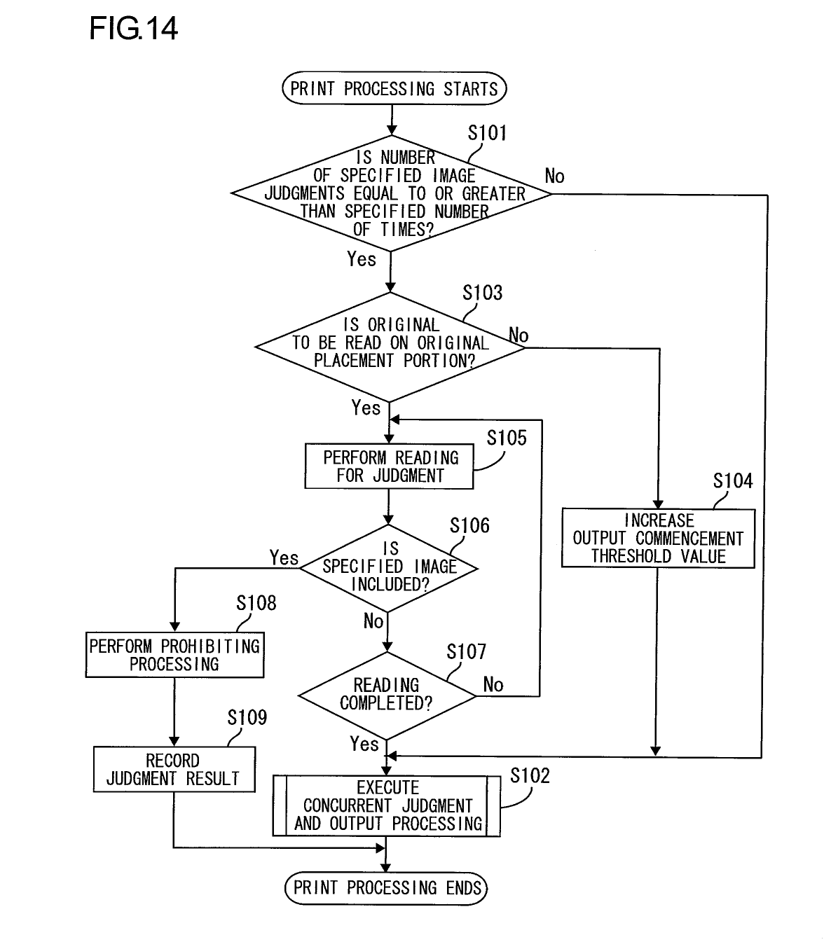

Next, a further illustrative aspect of this invention will be described with reference to the flowchart shown in FIG. 14.

According to this illustrative aspect, processing in a case where an original image that was read by the original reading portion 3 is printed out onto a recording medium 5 is described.

When the CPU 51 starts print processing, it first refers to history information stored in the nonvolatile memory 54 to determine if the number of specified image judgment (s) by the judging portion 61 is equal to or greater than the predetermined number (S101). When the number of times it is judged that specified image data is included is less than the predetermined number (S101: No), the CPU 51 executes concurrent judgment and output processing (see FIG. 7) (S102).

When the number of times it is judged that specified image data is included is equal to or greater than the predetermined number (S101: Yes), the CPU 51 determines if a reading operation is to be performed by the original reading portion 3 with respect to an original placed on the original placement portion 33 (S103). When a reading operation is not to be performed with respect to an original on the original placement portion 33 (S103: No), that is, when reading is to be performed by conveying an original placed on the original tray 36 using the ADF 34, the CPU 51 increases the output commencement threshold value (S104) and thereafter executes concurrent judgment and output processing (S102).

When a reading operation is to be performed by the original reading portion 3 with respect to an original placed on the original placement portion 33 (S103: Yes), the CPU 51 causes the original reading portion 3 to execute a reading operation for judgment (S105). The processing executed thereafter (S105 to S109, and S102) is the same as in the above described illustrative aspect (see FIG. 8) (S42 to S47). More specifically, when it is judged that the image data for judgment includes specified image data (S106: Yes), prohibiting processing (S108) and recording of the judgment result in the nonvolatile memory 54 (S109) is performed. Further, when it is determined that specified image data is not included in all of the image data for judgment (S106: No, S107: Yes), concurrent judgment and output processing is executed (S102).

According to this illustrative aspect, when reading an original that was placed on the original placement portion 33, since it is possible to read the same original multiple times, image data for judgment that is used only for judgment is acquired first, and after that judgment is completed, output is performed concurrently with acquisition of the image data for output. Further, when reading an original that is fed by the ADF 34, since it is not possible to read the same original multiple times, output by the image forming portion 10 is started at a time when image data of an amount that is less than the image data for judgment (that would be acquired by the original reading portion 3), and a judgment by the judging portion 61 and output by the image forming portion 10 are performed concurrently. As a result, the capacity of the storage means that is used can be reduced. Further, by using image data for a judgment, such a judgment can be made even when the capacity of the storage means is limited.

Although the above described illustrative aspects described a case in which image data acquired by reading an original image with the original reading portion 3 (as an acquiring means) is printed out on a recording medium 5, for a device that does not have original reading means as a component with respect to the present invention, this invention can also be applied to a case in which image data that was sent from an external information processing apparatus is acquired and printed out on the recording medium 5. In this case a configuration may be adopted in which, for example, image data (PDL data) from outside is acquired by the network interface 56 (as an acquiring means), and after expanding that image data, the image data is processed by the judging portion 61 and the image processing portion 62, respectively. In addition, for a device that is equipped with a facsimile function, the present invention can also be applied to a case of printing out image data that was received from outside through a telephone line onto a paper sheet.

Although the above described illustrative aspects described a case in which image data acquired by original reading means is printed out on a recording medium 5, the present invention can also be applied to a case in which image data acquired by original reading means is output to the external computer 58 or the like through the network interface 56 (as an outputting means). Similarly, for a device provided with, for example, a USB interface or other media connecting portion (as an outputting means), the present invention can also be applied to a case in which acquired image data is output to and stored in external media such as flash memory. The present invention can also be applied to a scanner as an image processing apparatus that is not equipped with image forming means. Further, for a device equipped with a facsimile function, the present invention can also be applied to a case of transmitting and outputting image data acquired by original reading means to outside via a telephone line.

Although according to the foregoing illustrative aspects, a laser printer that adopts a so-called direct-transfer type tandem system was exemplified as an image forming apparatus (image processing apparatus), the present invention is not limited thereto and can also be applied to a laser printer that adopts a different system such as an intermediate transfer tandem system or a four-cycle system, and can also be applied to an inkjet printer or the like.

Although according to the above described illustrative aspects a RAM was used as data storage means that stores image data, an image memory which is used exclusively to handle image data may be separately provided.

Further, a configuration may also be adopted in which image data is compressed and stored when storing the image data in storage means such as a RAM, and the image data is decompressed when reading out the image data.

When the “predetermined number” for specified image judgments is set as 1 time, it is sufficient that at least information regrading if the judging means has ever judged that specified image data is included in image data stored as history information in history storage means.

What is claimed is:

1. An image processing apparatus, comprising:
an acquiring portion that acquires image data;
a judging portion that determines if specified image data is included in image data that is acquired by the acquiring portion;
a history storage portion that stores history information relating to a number of times the judging portion judges that specified image data is included, wherein the number of times is X;
an outputting portion that capable of outputting the image data;
a prohibiting portion capable of at least one of stopping output of the image data and performing an invalidation output; and
a control portion that refers to the history information, and when X is less than a predetermined number, causes the outputting portion to start output the image data before a determination by the judging portion is completed, and when X is equal to or greater than the predetermined number, causes the outputting portion to start outputting the image data after the judging portion determines that the image data does not include specified image data.

2. The image processing apparatus according to claim 1, wherein the acquiring portion includes an original reading portion; and
when the number X is equal to or greater than a predetermined number, the control portion causes the original reading portion to acquire image data for a determination that is separate to image data for outputting by the outputting portion, and after the judging portion determines that the image data does not include specified image data, the control portion causes the outputting portion to output concurrently with acquisition of the image data for output by the original reading portion.

3. The image processing apparatus according to claim 2, wherein a reading operation for acquiring the image data for judgment by the original reading portion is performed at a lower resolution than a reading operation for acquiring the image data for output.

4. The image processing apparatus according to claim 1, further comprising a data storage portion that stores image data acquired by the acquiring portion, wherein
the acquiring portion includes an original reading portion that acquires image data by reading an original image; and
when the number X is equal to or greater than a predetermined number, the control portion causes image data that is acquired by the original reading portion to be stored in the data storage portion during a period until a determination by the judging portion is completed, and after the judging portion determines that the image data does not include specified image data, the control portion causes the outputting portion to output based on the image data that is stored in the data storage portion.

5. An image processing apparatus, comprising:
an acquiring portion that acquires image data;
a judging portion that determines if specified image data is included in the image data;
a history storage portion that stores history information relating to a number of times the judging portion determines that specified image data is included, wherein the number is X;
an outputting portion capable of outputting the image data;
a prohibiting portion capable of at least one of stopping output of the image data and performing an invalidation output; and
a control portion that refers to the history information, and when the number X is less than a predetermined number, causes the judging portion to make a determination based on a first judgment condition, and when the number X is equal to or greater than the predetermined number, causes the judging portion to make a determination based on a second judgment condition, wherein conditions for determining that a specified image is not included are stricter than in the first judgment condition.

6. The image processing apparatus according to claim 5, wherein the second judgment condition is stricter by including at least one of conditions related to color and conditions related to size.

7. The image processing apparatus according to claim 5, wherein the judging portion uses a concordance rate between the image data and reference data to determine if the specified image data is present; and
in the second judgment condition the concordance rate for judging that specified image data is included is low as compared to the concordance rate in the first judgment condition.

8. An image processing apparatus, comprising:
an acquiring portion that acquires image data;
a judging portion that determines if specified image data is included in the image data;
a history storage portion that stores history information relating to a number of times the judging portion determines that specified image data is included, wherein the number is X;
a data storage portion that stores image data that is acquired by the acquiring portion;
an outputting portion that capable of outputting the image data that is stored by the data storage portion;
a prohibiting portion capable of at least one of stopping output of the image data and performing an invalidation output; and
a control portion capable of accessing the history information, wherein the number X is less than a predetermined number, an amount of the image data that is stored in the data storage portion reaches a first threshold value the control portion causes the outputting portion to start output based on the image data, and when the number X is equal to or greater than the predetermined number, an amount of the image data that is stored in the data storage portion reaches a second threshold value that is greater than the first threshold value, the control portion causes the outputting portion to start output based on the image data.

9. An image processing apparatus, comprising:
an acquiring portion that acquires image data;
a judging portion that determines if specified image data is included in the image data;
a history storage portion that stores history information relating to a number of times the judging portion determines that specified image data is included, wherein the number is X;
an outputting portion that capable of outputting the image data;
a prohibiting portion capable of at least one of stopping output of the image data and performing an invalidation output; and
a control portion capable of accessing the history information, and performs control so that a time from acquisition of image data by the acquiring portion until commencement of output based on that image data by the outputting portion increases in accordance with an increase in the number X.

10. The image processing apparatus according to claim 1, wherein the acquiring portion includes an original reading portion that acquires image data by reading an original image.

11. The image processing apparatus according to claim 10, wherein the judging portion is capable of a main judgment processing that determines if specified image data is included in image data and a preliminary judgment processing that determines if there is a high possibility that specified image data is included in image data at a higher speed than the main judgment processing; and
when the judging portion determines by the preliminary judgment processing that there is not a high possibility that specified image data is included in image data, the control portion causes the outputting portion to start output before a determination according to the main judgment processing is completed, and when the judging portion judges by the preliminary judgment processing that there is a high possibility that specified image data is included, the control portion starts output by the outputting portion after the judging portion determines by the main judgment processing that the image data does not include specified image data.

12. The image processing apparatus according to claim 11, wherein in the preliminary judgment processing the judging portion uses a judgment item including at least one of a color and a size of an original image.

13. The image processing apparatus according to claim 10, wherein the original reading portion comprises an original placement portion on which an original is placed, a reading device that reads an original that is placed on the original placement portion, and an original feeding portion that conveys the original; and
when reading an original the control portion causes the original reading portion to acquire image data for judgment that is separate to image data output by the outputting portion, and after the judging portion determines that specified image data is not included in the image data for judgment, the control portion causes output to start concurrently with acquisition of the image data for output by the original reading portion, and when reading the original at a time when an amount of the image data is less than the amount of the image data for determination, the control portion causes the outputting portion to start output based on that image data, to perform output by the outputting portion and determination of the image data by the judging portion concurrently.

14. The image processing apparatus according to claim 1, wherein the predetermined number is one time.

15. The image processing apparatus according to claim 1, wherein the history storage portion includes a nonvolatile memory.

16. An image forming apparatus, comprising:
an original reading portion that acquires image data by reading an original image;
a judging portion that judges if specified image data is included in image data that is acquired by the original reading portion;
a history storage portion that stores history information relating to a number of times the judging portion judges that specified image data is included;
an image forming portion capable of printing onto a recording medium an image based on the image data;
a prohibiting portion capable of at least one of stopping output of the image data and performing an invalidation output; and
a control portion capable of accessing the history information, and when the number X is less than a predetermined number, causes the image forming portion to start printout based on the image data before completion of a determination by the judging portion, and when the number X is equal to or greater than a predetermined number, the control portion causes the image forming portion to start printout based on the image data after the judging portion determines that the image data does not include specified image data.

17. An image forming apparatus, comprising:
an original reading portion that acquires image data by reading an original image;
a judging portion that judges if specified image data is included in image data that is acquired by the original reading portion;
a history storage portion that stores history information relating to a number of times the judging portion judges that specified image data is included;
an image forming portion capable of printing onto a recording medium an image based on the image data;
a prohibiting portion capable of at least one of stopping output of the image data and performing an invalidation output; and
a control portion capable of access to the history information, and when a number X is less than a predetermined number, causes the judging portion to make a judgment based on a first judgment condition, and when the number X is equal to or greater than the predetermined number, causes the judging portion to make a judgment based on a second judgment condition wherein the second judgment condition includes more judgment items than in the first judgment condition.

18. An image forming apparatus, comprising:
an original reading portion that acquires image data by reading an original image;
a judging portion that judges if specified image data is included in image data that is acquired by the original reading portion;
a history storage portion that stores history information relating to a number of times the judging portion determines that specified image data is included, wherein the number is X;
a data storage portion that stores image data that is acquired by the original reading portion;
an image forming portion that prints onto a recording medium an image based on image data that is stored by the data storage portion;
a prohibiting portion capable of at least one of stopping output of the image data and performing an invalidation output; and
a control portion capable of accessing the history information, where the number X is less than a predetermined number, and when an amount of image data that is stored in the data storage portion reaches a first threshold value the control portion causes the image forming portion to start printout based on the image data, wherein the number X is equal to or greater than the predetermined number, and when an amount of image data that is stored in the data storage portion reaches a second threshold value that is greater than the first threshold value the control portion causes the image forming portion to start printout based on the image data.

19. An image forming apparatus, comprising:
an original reading portion that acquires image data by reading an original image;
a judging portion that judges if specified image data is included in image data that is acquired by the original reading portion;
a history storage portion that stores history information relating to a number of times the judging portion judges that specified image data is included;
an image forming portion that prints out onto a recording medium an image based on image data that is acquired by the original reading portion;
a prohibiting portion that, in a case where the judging portion judges that specified image data is included in acquired image data, causes the image forming portion to stop printout thereof or to perform an invalidated printout; and
a control portion capable of accessing the history information and performs control so that a time from acquisition of image data by the acquiring portion until commencement of printout based on that image data by the image forming portion increases in accordance with an increase in the number of times that the judging portion judges that specified image data is included.
